(19) United States
(12) Patent Application Publication
(10) Pub. No.: US 2025/0287917 A1
(43) Pub. Date: Sep. 18, 2025

(54) ILLUMINATED ANIMAL OUTERWEAR

(71) Applicant: QUINN VOGT, BRIGHTON, MI (US)

(72) Inventor: QUINN VOGT, BRIGHTON, MI (US)

(21) Appl. No.: 19/081,239

(22) Filed: Mar. 17, 2025

Related U.S. Application Data
(60) Provisional application No. 63/566,835, filed on Mar. 18, 2024.

(51) Int. Cl. A01K 13/00

(52) U.S. Cl. CPC A01K 13/006

(57) ABSTRACT

The present disclosure relates to an animal garment designed to provide enhanced comfort, protection, and functionality. The garment comprises an exterior surface formed of a water-resistant material, an interior lining providing thermal insulation, and a fastening device for secure attachment. It includes adjustable fit mechanisms to accommodate various animal body types and may feature an illumination portion configured to receive an illumination device for enhanced visibility. The garment may also include light-reflective elements, elastic components for improved conformity, and reinforced stitching for durability. A selectively attachable collar portion is designed to prevent heat loss and enhance comfort. Additional features include pockets for storage and a flap to prevent direct contact between fastening devices and the animal's fur. The garment is constructed from washable and reusable materials while maintaining water-resistant and thermal properties. This innovation enhances pet safety, comfort, and usability in various environmental conditions.

### CROSS-REFERENCE TO RELATED APPLICATIONS

This application claims priority to U.S. Provisional Application No. 63/566,835, filed on Mar. 18, 2024, which is incorporated by reference herein in its entirety.

### BACKGROUND OF THE DISCLOSURE

This disclosure is directed to an accessory for animals, including but not limited to pets. The disclosure is also directed to an article of clothing, garment, outerwear, a coat or vest, for example, and without limitation, for animals and pets that may be worn by them that may further include illumination elements to increase their visibility for their safety and that of others.

Animals, including but not limited to dogs and cats, often spend time outdoors. This time outdoors allows them to run, exercise, explore, and do other activities. Of course, not all of the time spent outdoors is during daylight hours, when people caring for the animals are often supervising their activities.

In times of darkness or low visibility, such as during the winter months, people supervising animals may find it difficult to see the animals, even if they are relatively close by. For example, a dog owner may let their dog out of their home into a dark yard or garden. Due to the low light conditions (e.g., in darkness, fog, rain, or snow) as well as the color of the dog, the owner may quickly lose sight of their dog. In another example, a dog owner may live in a rural area, and their dog may be allowed to run about an expansive property including high grass, brush, and other obstacles limiting the dog owner's ability to maintain visible contact with their dog. This can be an unnerving experience for the dog owner due to numerous hazards that their dog may encounter out of their line of sight.

In other situations, other animals (including but not limited to dog) may be allowed to roam over large areas. For example, livestock may be placed in large pastures or grazing areas and those people charged with supervising those animals may also lose visible contact with their animals due to low light conditions, darkness, poor weather, etc. As in the previous example, animals that are not sufficiently supervised may encounter hazards that could jeopardize their health and safety.

What is needed then is an illuminated animal garment or outerwear that conforms to the shape of the animal and includes illumination devices to increase the visibility of the animal wearing the coat.

### SUMMARY OF THE DISCLOSURE

The present disclosure overcomes the problems and disadvantages associated with current strategies and designs and provides new tools and methods for illuminated pet safety outerwear.

One embodiment of the disclosure is directed to an article of clothing/outerwear for an animal that may be in the form of a coat or vest.

Another embodiment of the disclosure is directed to an article of clothing for an animal that may be in the form of a coat/vest that includes an exterior surface and an interior surface that may be formed of a cotton fabric.

Another embodiment of the disclosure is directed to an article of clothing for an animal that may be in the form of a coat that includes an exterior surface that may be formed of a water-repellent fabric.

Another embodiment of the disclosure is directed to an article of clothing for an animal that may be in the form of a coat that includes an exterior surface that may be formed of a combination of a cotton fabric with water-repellent properties.

Another embodiment of the disclosure is directed to an article of clothing for an animal that may be in the form of a coat that includes an exterior surface that may be formed of a nylon fabric.

Another embodiment of the disclosure is directed to an article of clothing for an animal that may be in the form of a coat that includes an exterior surface that may be formed of a water-repellent nylon fabric.

Another embodiment of the disclosure is directed to an article of clothing for an animal that may be in the form of a coat that includes an exterior surface that may be formed of a water-repellent, polyurethane coated nylon fabric.

Another embodiment of the disclosure is directed to an article of clothing for an animal that may be in the form of a coat that includes two halves to form the front portion of the coat.

Another embodiment of the disclosure is directed to an article of clothing for an animal that may be in the form of a coat that includes two halves to form a first portion of the coat that conforms to the back of the animal.

Another embodiment of the disclosure is directed to an article of clothing for an animal that may be in the form of a coat that includes a second portion that conforms to the belly of the animal.

Another embodiment of the disclosure is directed to an article of clothing for an animal that may be in the form of a coat that includes two halves to form a first portion of the coat and a second portion that conforms to the back of the animal.

Another embodiment of the disclosure is directed to an article of clothing for an animal that may be in the form of a coat that includes two halves to form a first portion of the coat and a second portion that conforms to the back of the animal, wherein the first portion and the second portion is joined together.

Another embodiment of the disclosure is directed to an article of clothing for an animal that may be in the form of a coat that includes two halves to form a first portion of the coat and a second portion that conforms to the back of the animal, wherein the first portion and the second portion is selectively joined together.

Another embodiment of the disclosure is directed to an article of clothing for an animal that may be in the form of a coat that includes two halves to form a first portion of the coat and a second portion that conforms to the back of the animal, wherein the first portion and the second portion is joined together and includes a third portion, a lining that is disposed on one side of the article of clothing, the side that engages the exterior surface (e.g., hair, fur) of the animal.

Another embodiment of the disclosure is directed to an article of clothing for an animal that may be in the form of a coat that includes two halves to form a first portion of the coat and a second portion that conforms to the back of the animal, wherein the first portion and the second portion is joined together and includes a third portion, a lining that is disposed on one side of the article of clothing, the side that engages the exterior surface (e.g., hair, fur) of the animal.

Another embodiment of the disclosure is directed to an article of clothing for an animal that may be in the form of a coat that includes a lining that may be constructed of a variety of materials, or a combination of materials.

Another embodiment of the disclosure is directed to an article of clothing for an animal that may be in the form of a coat that includes a lining that may be constructed of a variety of materials, or a combination of materials including but not limited to, fleece, cotton flannel, or water-repellent, polyurethane coated nylon fabric.

Another embodiment of the disclosure is directed to an article of clothing for an animal that may be in the form of a coat that includes a lining that may be constructed in one or more portions that may correspond to other portions of the article of clothing.

Another embodiment of the disclosure is directed to an article of clothing for an animal that may include elastic included into one or more portions or sections of the article of clothing for improved conformity with the exterior surface of the animal.

Another embodiment of the disclosure is directed to an article of clothing for an animal that may include a collar that may engage the first, second, and/or third portions of the article of clothing.

Another embodiment of the disclosure is directed to an article of clothing for an animal that may include a collar from rib knit cuff trim that may engage the first, second, and/or third portions of the article of clothing.

Another embodiment of the disclosure is directed to an article of clothing for an animal that may include a collar from rib knit cuff trim that may engage via stitching the first, second, and/or third portions of the article of clothing.

Another embodiment of the disclosure is directed to an article of clothing for an animal that may include a zipper or other selectable fastening device (e.g., snaps, buttons, hook-and-loop fastener, etc.), to secure the article of clothing to the animal.

Another embodiment of the disclosure is directed to an article of clothing for an animal that may include a zipper or other selectable fastening device (e.g., snaps, buttons, hook-and-loop fastener, etc.), to secure the article of clothing to the animal that also includes a flap portion to isolate the selectable fastening device from the exterior surface (i.e., hair, fur) of the animal.

Another embodiment of the disclosure is directed to an article of clothing for an animal that may include a zipper or other selectable fastening device (e.g., snaps, buttons, hook-and-loop fastener, etc.), to secure the article of clothing to the animal that may also include a flap portion to isolate the selectable fastening device from the exterior surface (i.e., hair, fur) of the animal, wherein the selectable fastening device may be secured to the flap portion.

Another embodiment of the disclosure is directed to an article of clothing for an animal that may include a plurality of extremity (e.g., head, feet, tails, etc.) holes disposed about the article of clothing that may be finished with fold-over elastic or other suitable finishing techniques and methods.

Another embodiment of the disclosure is directed to an article of clothing for an animal that may include at least one pocket that may be secured to the article of clothing.

Another embodiment of the disclosure is directed to an article of clothing for an animal that may include at least one pocket that may be constructed of a plurality of materials, including but not limited to cotton, nylon, or other polymer materials, or a combination thereof.

Another embodiment of the disclosure is directed to an article of clothing for an animal that may include at least one illumination portion.

Another embodiment of the disclosure is directed to an article of clothing for an animal that may include at least one illumination portion, wherein the illumination portion is configured in the form of a pocket to selectively receive an illumination device.

Another embodiment of the disclosure is directed to an article of clothing for an animal that may include at least one illumination portion, wherein the illumination portion is configured in the form of a pocket that may be constructed out of one or more materials of the article to selectively receive an illumination device.

Another embodiment of the disclosure is directed to an article of clothing for an animal that may include at least one illumination portion, wherein the illumination portion is configured in the form of a pocket that may be constructed out of one or more materials of the article to selectively receive an illumination device and may include a selectively securable fastener to retain the illumination device within the illumination portion.

Another embodiment of the disclosure is directed to an article of clothing for an animal that may include at least one illumination portion, wherein the illumination portion is configured in the form of a pocket that may be constructed out of one or more materials of the article to selectively receive an illumination device, wherein the illumination device may be configured as, but not limited to, a rechargeable light source (e.g., light-emitting diode (LED)), a chemical luminescent light source (e.g., glow stick), or other suitable light source.

Another embodiment of the disclosure is directed to an article of clothing for an animal that may include at least one light reflective (e.g., a retroreflector) device.

Another embodiment of the disclosure is directed to an article of clothing for an animal that may be configured in whole or in part to be washable and/or reusable.

Another embodiment of the disclosure is directed to an animal garment including an exterior surface of the animal garment formed of a water-repellent fabric, an interior surface of the animal garment formed of a cotton fabric, at least one fastening device configured to secure the animal garment to an animal, and a selectively adjustable fitment mechanism configured to conform the animal garment to a body of the animal, wherein the exterior surface of the animal garment is resistant to environmental elements, including water and wind, and the interior surface of the animal garment is configured to provide thermal insulation and comfort.

Another embodiment of the disclosure is directed to an animal garment where the exterior surface of the animal garment comprises a nylon fabric.

Another embodiment of the disclosure is directed to an animal garment where the exterior surface of the animal garment comprises a water-repellent, polyurethane-coated nylon fabric.

Another embodiment of the disclosure is directed to an animal garment where the animal garment is structured to accommodate various animal body types through the selective use of elastic sections and adjustable fasteners.

Another embodiment of the disclosure is directed to an animal garment further including two halves forming a first portion of the animal garment configured to conform to the back of the animal, wherein the first portion of the animal garment includes reinforced stitching for durability.

Another embodiment of the disclosure is directed to an animal garment where a second portion of the animal garment configured to conform to the belly of the animal, wherein the second portion of the animal garment is selectively attachable to the first portion of the animal garment.

Another embodiment of the disclosure is directed to an animal garment where the first portion of the animal garment and the second portion of the animal garment are joined together by a fastening device selected from the group comprising zippers, snaps, buttons, and hook-and-loop fasteners.

Another embodiment of the disclosure is directed to an animal garment where the first portion of the animal garment and the second portion of the animal garment are joined together by a fastening device and further include an insulating lining disposed between the interior surface and exterior surface of the animal garment.

Another embodiment of the disclosure is directed to an animal garment further including a third portion, wherein the third portion of the animal garment is configured to provide additional coverage of the animal and includes a lining disposed on an interior side of the animal garment that selectively engages the exterior surface of the animal.

Another embodiment of the disclosure is directed to an animal garment where the lining is constructed from at least one of fleece, cotton flannel, or water-repellent, polyurethane-coated nylon fabric.

Another embodiment of the disclosure is directed to an animal garment including a first portion of the animal garment configured to conform to a back of an animal, a second portion of the animal garment configured to conform to a belly of the animal, a collar portion of the animal garment formed of rib knit cuff trim, and at least one fastening device configured to secure the animal garment to the animal, where the collar portion is structured to prevent heat loss and enhance comfort by securing engagement with at least one of the first portion or the second portion of the animal garment.

Another embodiment of the disclosure is directed to an animal garment where the fastening device comprises at least one element selected from the group comprising zippers, snaps, buttons, and hook-and-loop fasteners.

Another embodiment of the disclosure is directed to an animal garment further including a flap portion of the animal garment configured to isolate the fastening device from contact with the animal's fur, hair or skin, thereby preventing discomfort or entanglement.

Another embodiment of the disclosure is directed to an animal garment where the fastening device is secured to the flap portion of the animal garment to enhance durability and maintain secure attachment of the animal garment.

Another embodiment of the disclosure is directed to an animal garment including an exterior surface of the animal garment formed of a water-resistant material, an interior lining of the animal garment providing thermal insulation, at least one fastening device of the animal garment, and at least one illumination portion of the animal garment configured to receive an illumination device, where the illumination portion is structured as a pocket constructed from materials of the animal garment and includes a selectively securable fastener for retaining the illumination device in a fixed position.

Another embodiment of the disclosure is directed to an animal garment where the illumination device is selected from the group comprising a rechargeable light source, a chemical luminescent light source, a replaceable battery-powered light source, or a solar-powered light source.

Another embodiment of the disclosure is directed to an animal garment further including at least one of a light-reflective and a photo-reflective device disposed on at least one of the exterior surface of the animal garment or the illumination portion of the animal garment to enhance nighttime visibility of the animal garment.

Another embodiment of the disclosure is directed to an animal garment further including at least one elastic portion of the animal garment incorporated into at least one component of the animal garment to facilitate a secure and flexible fit for different animal sizes and body structures.

Another embodiment of the disclosure is directed to an animal garment further comprising at least one pocket of the animal garment constructed from at least one material selected from the group comprising cotton, nylon, polymer material, a natural material, or a synthetic material.

Another embodiment of the disclosure is directed to an animal garment wherein the components of the animal garment are configured to be washable and reusable while maintaining water-resistant and thermal properties.

### BRIEF DESCRIPTION OF DRAWINGS

The disclosure is described in greater detail by way of example only and with reference to the attached drawings, in which:

FIG. 1 is a top view of an embodiment of the present disclosure, configured as a closed coat including a pair of illuminating devices;

FIG. 2 is a bottom view of an embodiment of the present disclosure, configured as a closed coat;

FIG. 3 is a right-side view of an embodiment of the present disclosure, configured as a closed coat;

FIG. 4 is a left-side view of an embodiment of the present disclosure, configured as a closed coat;

FIG. 5 is a top view of an embodiment of the present disclosure, configured as an open coat; and

FIG. 6 is a bottom view of an embodiment of the present disclosure, configured as an open coat.

FIG. 7A is a top view of an illumination device according to an embodiment of the present disclosure;

FIG. 7B is a top view of an illumination device charging cord according to an embodiment of the present disclosure;

FIG. 8 is a side view of a dog wearing an embodiment of the present disclosure;

FIG. 9 is a profile view of a dog wearing an embodiment of the present disclosure including a pair of illuminating devices;

FIG. 10 is a profile view of a dog wearing an embodiment of the present disclosure including a pair of illuminating devices;

FIG. 11 is a profile view of the dog wearing an embodiment of the present disclosure including a pair of illuminating devices that are illuminated; and

FIG. 12 is a profile view of two dogs wearing an embodiment of the present disclosure including a pair of illuminating devices.

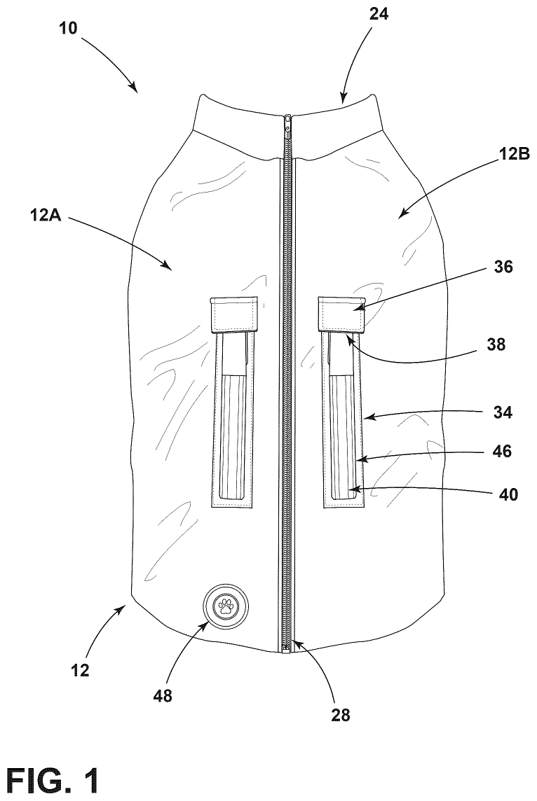

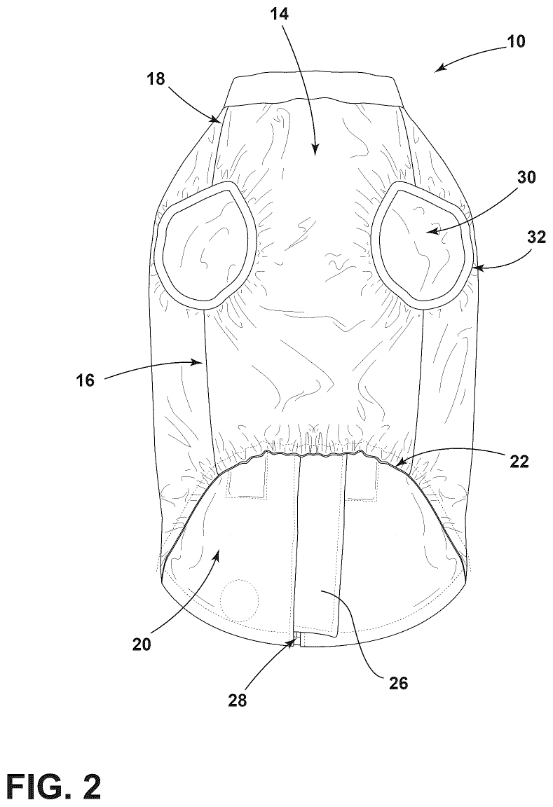

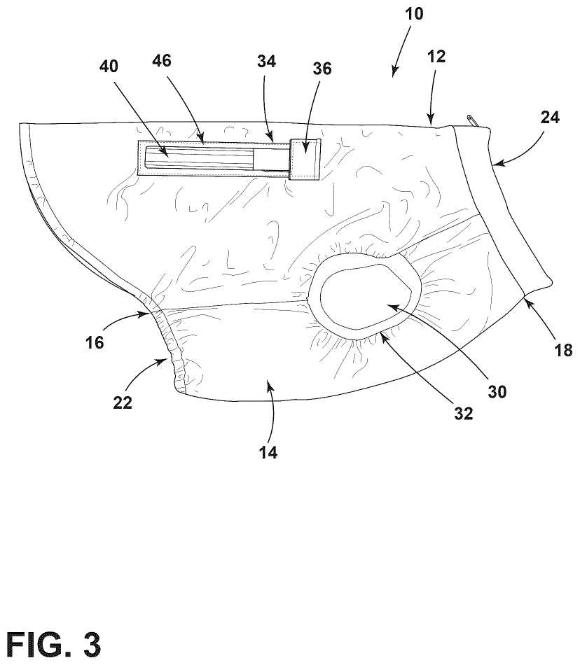

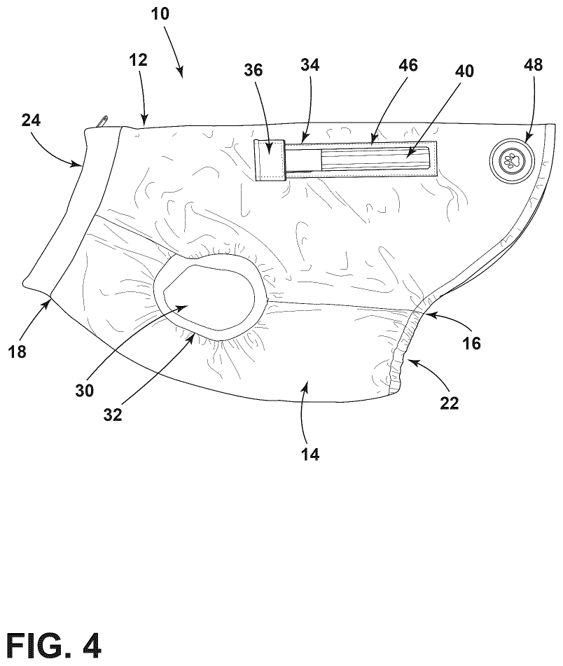

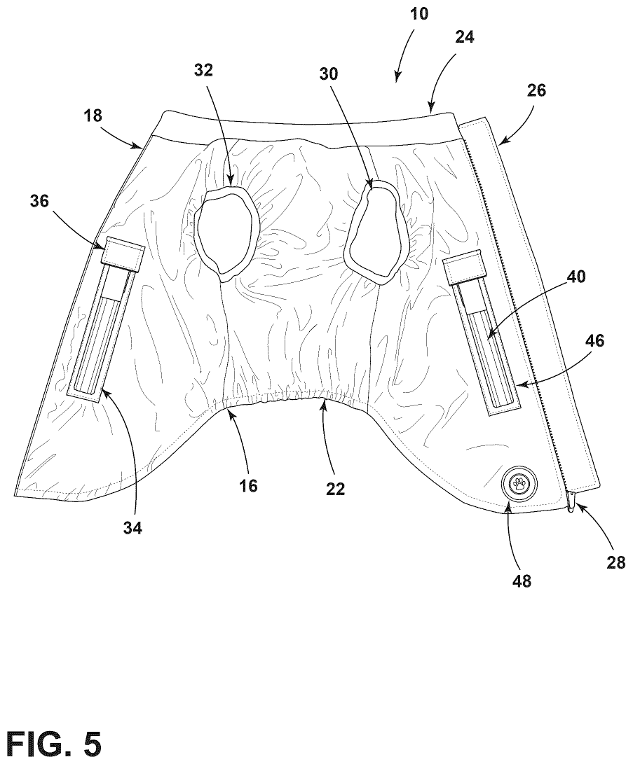

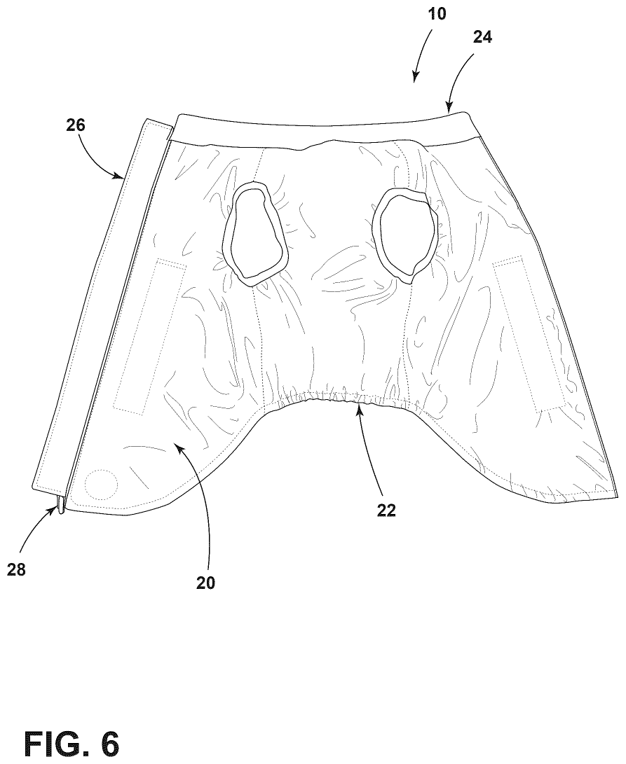

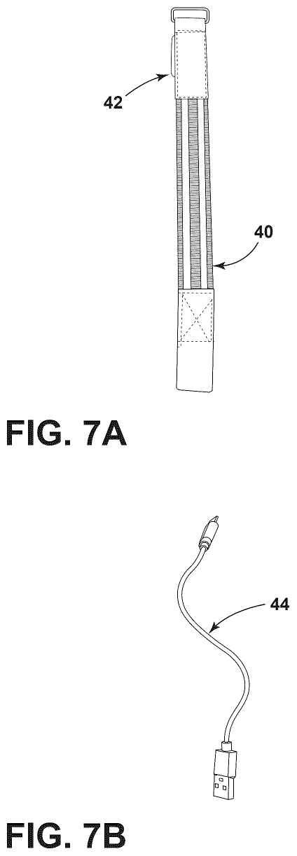

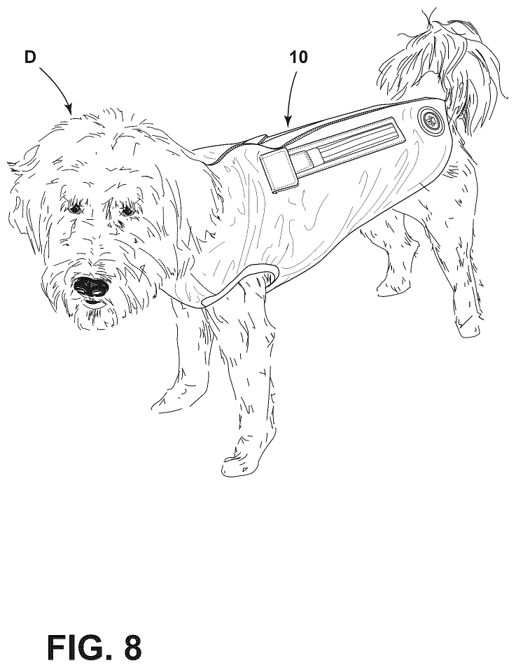

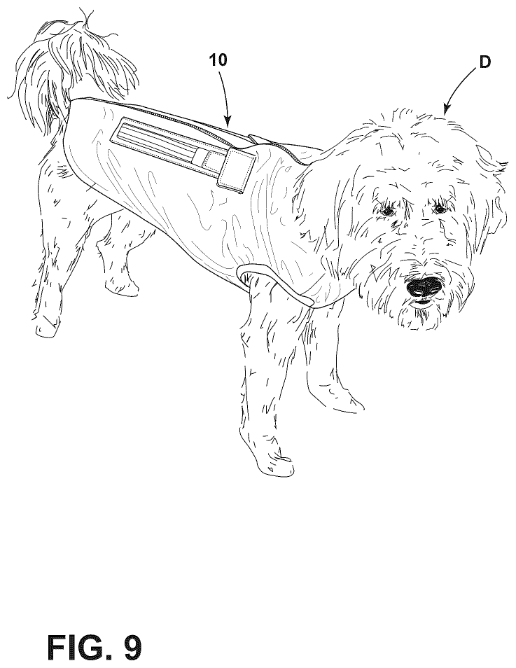

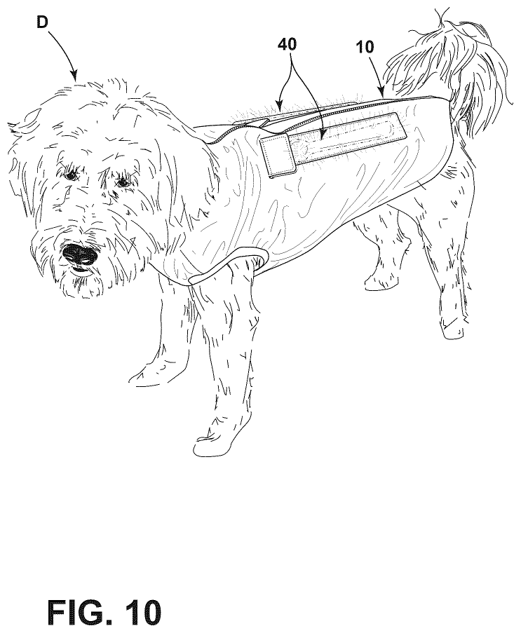

### DETAILED DESCRIPTION OF THE DISCLOSURE

As embodied and broadly described herein in the Drawings, the present disclosure is directed to an illuminated animal outerwear or garment (e.g., “coat”) 10. It should be understood that the term coat includes any and all articles of clothing or outerwear that may be worn or applied to animals including pets, livestock, and other living creatures.

According to embodiments of the disclosure, many dog owners live in areas that experience darkness or low light conditions for a large portion of the day. For example, in the winter in northern climates, darkness lasts longer than daylight hours. Despite the lack of daylight in certain times of the year, dog owners still want to exercise their dogs as well as let them outside to perform biological functions.

Whether dog owners use leashes, let their dogs run in an enclosed area, or let their dogs run around an extensive property-if there is limited ambient light it is easy for dog owners to lose sight of their dogs. This situation is further enhanced if their dogs are dark in color.

It is important for dog owners to keep their dogs in sight and under control, whether or not their dogs are leashed. For example, in an urban environment, a dog owner walking their dog may share the area with pedestrians, runners, and motor vehicles. The illuminated pet safety coat of the present disclosure is intended to improve the safety of both dogs wearing the coats but also of pedestrians, runners, and others in the surrounding area by increasing the visibility of dogs.

In embodiments of the present disclosure, light sources are disposed along the portion of the coat that corresponds to the back of the dog, so that other people and the dog owner may more easily see and locate the dog relative to their location. In addition, reflective elements of the coat further improve visibility of the dog wearing the coat by reflecting light projected from other light sources. These light sources include motor vehicles, bicycles, flashlights, and other local light sources (e.g., streetlights).

By making their dogs more visible when wearing the coat of the present disclosure, dog owners can enjoy exercising their dogs outdoors and worry less about the safety of their dogs. For dog owners walking their dogs, a more highly visible dog wearing the coat makes it easier for other pedestrians, runners, and motor vehicles to see the dog, and by extension, the dog owner holding the dog's leash.

Another advantage of the coat of the present disclosure is the situation of an escaping dog. If a dog wearing the coat were to break free from its leash or get out of its enclosure, the illuminated coat enables the dog owner to see their dog from a greater distance and move in its direction. For example, if the dog owner were camping and their dog escaped, the illuminated coat makes locating their dog in a strange environment much easier.

Yet another advantage of the coat of the present disclosure is the protection that it provides to the dog wearing the coat. The coat includes thermal protection from the cold with its interior lining, and its exterior surface also protects the dog from water, dirt, weeds, and other debris that dogs often encounter when exercising outdoors. As the coat is fully washable, it is easy for the dog owner to clean and prepare for the next outing.

In other embodiments, the coat of the present disclosure may be used with other animals, such as livestock. For example, a herd of animals may be equipped with the coats to better supervise their movements in low-light conditions. Additional advantages of the coats employed on livestock may be realized, such as a deterrent to certain predators or to deter theft of the animals.

In other embodiments, the coat of the present disclosure may be used in other applications, such as search-and-rescue (SAR) dogs used in emergency situations. For example, in the case of a building collapse, SAR dogs are often sent into the rubble to locate victims. These SAR dogs, wearing the coats of the present disclosure will be easier for both rescuers and victims alike to spot at a longer distance and in low-light conditions.

In other embodiments, police dogs may be equipped with the coats in a police motif. The light strips may be configured as police lights to alert people of the dogs' presence and purpose in police situations, at airports, customs areas, and other police dog situations.

In other embodiments, service dogs may be equipped with the coat to further enhance the safety of their assigned owners. By denoting a service dog and increasing their visibility, particularly in high density traffic situations, the safety of the service dog and its owner may be greatly improved.

The light sources of the coat may be configured as rechargeable light emitting diodes (LEDs) and/or include reflective portions that redirect light toward its source. A dog owner may easily replace a depleted LED light source with a fully charged replacement or quickly recharge it using another power source.

The preceding examples illustrate embodiments of the disclosure, but should not be viewed as limiting the scope of the disclosure.

Other embodiments and uses of the disclosure will be apparent to those skilled in the art from consideration of the specification and practice of the disclosure disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the following claims.

Referring now to the Drawings, a coat or garment 10 of the present disclosure is shown. The coat 10 may be configured with a mirrored pair of outer layers 12A, 12B. The outer layer 12 may be constructed of a variety of materials, such as but not limited to cotton fabric or a water repellent polyurethane nylon fabric in a variety of colors. It is contemplated that other materials may be used to construct outer layer 12 as well as other elements of the coat of the present disclosure.

The pair of outer layers 12A, 12B form the front of the coat 10 that in some embodiments lays on the back of the dog D. The outer layers 12A, 12B and belly portion 14 are joined together by side seams 16 and shoulder seams 18 using, for example, all purpose thread.

The lining layer 20 may be made from a variety of materials, such as but not limited to, fleece, cotton flannel, or water repellent, polyurethane coated nylon fabric in a variety of colors. The lining layer 20 may be configured in the same shape as outer layers 12A, 12B.

The outer layers 12A, 12B and belly piece 14 of the lining layer 20 may be sewn together at the side and shoulder seams 16, 18 using, for example, all-purpose thread. The outer layers 12A, 12B and belly piece 14 of the lining layer 20 may be sewn together to form the coat 10. Elastic 22 may be sewn into the belly portion 14 of the coat 10 to better conform to the body of the dog D. The bottom of the outer and inner layers 12A, 12B, and 20 may be sewn together in some embodiments.

The collar 24 of the coat 10 may be made from rib knit cuff trim. The collar 24 may be sewn to the outer layer 12A, 12B, and the belly piece 14.

The coat 10 may include a zipper flap 26 that may be made from the same material as the outer layer 12A, 12B and/or the lining layer 20 of the body of the coat 10. It is contemplated that other fasteners apart from zippers 28 may be used, such as but not limited to, snaps, buttons, hook-and-loop fasteners, as well as other mechanical fasteners that may be suitable. The zipper flap 26 provides protection for the dog D from hair or fur becoming entangled in the zipper 28 or other mechanical fastener when the coat 10 is place on or removed from the dog D.

The zipper 28 or another suitable mechanical fastener may be sewn into zipper flap 26. The zipper 28 may then be used to join the outer layers 12A, 12B and their respective lining layer 20 that form the front of the coat 10.

The coat 10 may include limb holes 30 that may be finished with fold-over elastic 32. The fold-over elastic 32 enables the limb holes of the coat 10 to stay close to the body of the dog D and may also prevent water, dirt, or other debris from getting behind the coat 10 and to the hair or fur of the dog D.

In some embodiments, two light pockets 34 may be constructed out of clear vinyl to more easily allow light transmission through the light pockets 34, increasing the visibility of the dog D wearing the coat 10. The two light pockets 34 may be attached to the coat 10 using all-purpose thread and a straight stitch, or any other suitable thread and sewing or attachment technique. Two light pocket flaps 36 may be constructed from the same material as the outer layers 12 and the lining layer 20 of the coat 10. In embodiments, a one-inch (2.54 cm) first half of a hook-and-loop fastener 38 may be sewn into the lining fabric of each light pocket flap 36. The light pocket flap 36 outer and inner lining layers may be sewn together in the same configuration as the other elements of the coat 10 and then may be sewn onto the coat 10 above the light pockets 34. A one-inch (2.54 cm) of mating second half hook-and-loop fastener 38 may be secured to the vinyl light pockets 34 opposite the first piece of hook-and-loop fastener 38 on the light pocket flap 36. The hook-and-loop fastener 38 selectively secures the light strips 40 inside the light pockets 34 when the light pocket flap 36 is folded and engaged.

The light strips 40 may be configured as light-emitting diodes (LEDs). It is contemplated that other light sources may be used that are appropriate in this application. The light strips may be configured in a variety of colors and light outputs (e.g., flashing, strobe effect, etc.). The light strips 40 may be powered by rechargeable batteries 42. The light strips 40 with their rechargeable batteries 42 may be recharged using a charging cord 44. In embodiments, charging cord 44 may be configured with a variety of connectors, including various universal serial bus (USB) connectors or other connectors that may be appropriate or developed. The light strips 40 may be inserted into the light pockets 34 and secured by light pocket flaps 36 and hook-and-loop fasteners 38. The coat 10 may also include reflective strips 46 that may be disposed with light strips 40 in some embodiments or located at other locations on coat 10.

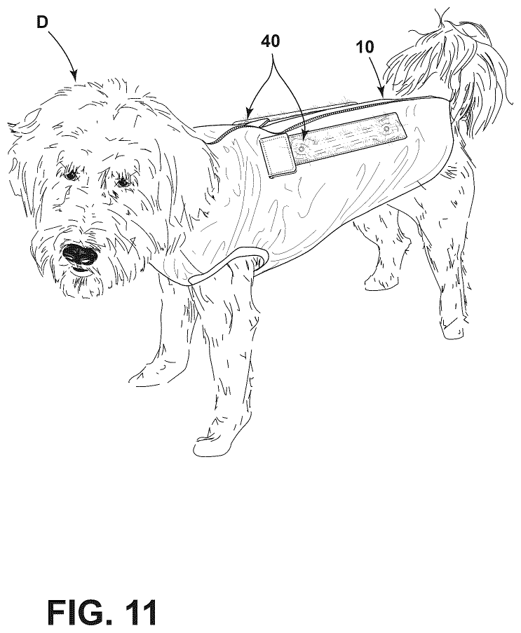

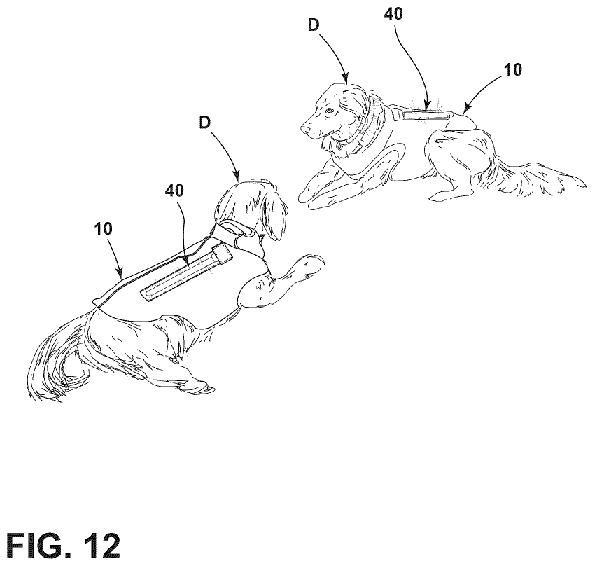

In embodiments, light strips 40 may be configured to display different light outputs (see FIG. 11) depending on a variety of parameters. For example, if the dog D is moving, the light strips 40 may be configured to flash to increase visibility. If the dog D stops moving, then the light strips 40 may be configured to be a solid (unblinking) light source. In other embodiments, if the dog D stops moving for a period of time, the light strips 40 may shift from a solid light to a blinking light.

The coat 10 may also include a logo, emblem, or patch 48. The patch 48 may be located throughout the coat 10. The patch 48 may be removable, such as using Velcro® and may include manufacturer name, the name of the animal/pet, the name of the owner, or other relevant information. In alternative embodiments, the logo may be configured as an accessory item to enhance the personalization of the coat 10. For example, the logo may be configured as removeable (i.e., changeable) designs so that a user may customize the coat 10. To further illustrate this embodiment, a user may desire to add “flames” to the coat 10 to make their animal wearing the coat 10 to be more personalized. In another embodiment, a user may choose to show their support for a particular sports team and replace or add a logo 48 to the coat 10. The logo 48 may be configured to accept user-prepared “craft” style items such as those for particular seasons, celebrations, etc. The logo 48 of coat 10 allows for extensive user customization and personalization of coat 10 to show their personality as well as of the animal wearing coat 10.

Various modifications and alterations to the specific embodiments described above will be apparent to those skilled in the art. All such variations are included within the scope and spirit of the disclosure. For example, and without limitation, the coat 10 may include name personalization using reflective iron-on material, one or more ruffles or other decorative flourishes, such as but not limited to, bow ties.

The preceding examples illustrate embodiments of the disclosure, but should not be viewed as limiting the scope of the disclosure.

Other embodiments and uses of the disclosure will be apparent to those skilled in the art from consideration of the specification and practice of the disclosure as disclosed herein. All references cited herein, including all publications, U.S. and foreign patents and patent applications, are specifically and entirely incorporated by reference. The term comprising, wherever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the following claims.

1. An animal garment comprising:
an exterior surface of the animal garment formed of a water-repellent fabric;
an interior surface of the animal garment formed of a cotton fabric;
a fastening device configured to secure the animal garment to an animal; and
a selectively adjustable fitment mechanism configured to conform the animal garment to a body of the animal;
wherein the exterior surface of the animal garment is resistant to environmental elements, including water and wind, and the interior surface of the animal garment is configured to provide thermal insulation and comfort.

2. The animal garment of claim 1, wherein the exterior surface of the animal garment comprises a nylon fabric.

3. The animal garment of claim 1, wherein the exterior surface of the animal garment comprises a water-repellent, polyurethane-coated nylon fabric.

4. The animal garment of claim 1, wherein the animal garment is structured to accommodate various animal body types through the selective use of elastic sections and adjustable fasteners.

5. The animal garment of claim 1, further comprising two halves forming a first portion of the animal garment configured to conform to the back of the animal, wherein the first portion of the animal garment includes reinforced stitching for durability.

6. The animal garment of claim 5, further comprising a second portion of the animal garment configured to conform to the belly of the animal, wherein the second portion of the animal garment is selectively attachable to the first portion of the animal garment.

7. The animal garment of claim 6, wherein the first portion of the animal garment and the second portion of the animal garment are joined together by a fastening device selected from the group comprising zippers, snaps, buttons, and hook-and-loop fasteners.

8. The animal garment of claim 6, wherein the first portion of the animal garment and the second portion of the animal garment are joined together by a fastening device and further include an insulating lining disposed between the interior surface and exterior surface of the animal garment.

9. The animal garment of claim 6, further comprising a third portion, wherein the third portion of the animal garment is configured to provide additional coverage of the animal and includes a lining disposed on an interior side of the animal garment that selectively engages the exterior surface of the animal and a logo portion, wherein the logo portion is configured to selectively receive a logo.

10. The animal garment of claim 9, wherein the lining is constructed from fleece, cotton flannel, or water-repellent, polyurethane-coated nylon fabric.

11. An animal garment comprising:
a first portion of the animal garment configured to conform to a back of an animal;
a second portion of the animal garment configured to conform to a belly of the animal;
a collar portion of the animal garment formed of rib knit cuff trim; and
a fastening device configured to secure the animal garment to the animal;
wherein the collar portion is structured to prevent heat loss and enhance comfort by securing engagement with the first portion or the second portion of the animal garment.

12. The animal garment of claim 11, wherein the fastening device comprises an element selected from the group comprising zippers, snaps, buttons, and hook-and-loop fasteners.

13. The animal garment of claim 12, further comprising a flap portion of the animal garment configured to isolate the fastening device from contact with the animal's fur, hair or skin, thereby preventing discomfort or entanglement.

14. The animal garment of claim 13, wherein the fastening device is secured to the flap portion of the animal garment to enhance durability and maintain secure attachment of the animal garment.

15. An animal garment comprising:
an exterior surface of the animal garment formed of a water-resistant material;
an interior lining of the animal garment providing thermal insulation;
a fastening device of the animal garment; and
an illumination portion of the animal garment configured to receive an illumination device;
wherein the illumination portion is structured as a pocket constructed from materials of the animal garment and includes a selectively securable fastener for retaining the illumination device in a fixed position.

16. The animal garment of claim 15, wherein the illumination device is selected from the group comprising a rechargeable light source, a chemical luminescent light source, a replaceable battery-powered light source, or a solar-powered light source.

17. The animal garment of claim 15, further comprising a light-reflective or a photo-reflective device disposed on of the exterior surface of the animal garment or the illumination portion of the animal garment to enhance nighttime visibility of the animal garment.

18. The animal garment of claim 15, further comprising an elastic portion of the animal garment incorporated into a component of the animal garment to facilitate a secure and flexible fit for different animal sizes and body structures.

19. The animal garment of claim 15, further comprising one or more pockets of the animal garment constructed from a material selected from the group comprising cotton, nylon, polymer material, a natural material, or a synthetic material.

20. The animal garment of claim 15, further comprising a logo disposed on one or more surfaces of components of the animal garment; wherein the components of the animal garment are configured to be washable and reusable while maintaining water-resistant and thermal properties.
